(19) United States
(12) Patent Application Publication
(10) Pub. No.: US 2002/0121501 A1
(43) Pub. Date: Sep. 5, 2002

(54) Reduction of sodium contamination in a semiconductor device

(76) Inventors: Scott F. Choquette, Orlando, FL (US); Brian David Crevasse, Apopka, FL (US); Charles J. Wood, Kissimmee, FL (US); David Allen Knorr, Orlando, FL (US); Stephen Ward Downey, Orlando, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/799,395

(22) Filed: Mar. 5, 2001

(51) Int. Cl. C23F 1/00; B44C 1/22; C03C 15/00

(52) U.S. Cl. 216/67; 156/345.35

(57) ABSTRACT

A plasma etcher for processing a semiconductor wafer and avoid sodium contamination is provided. The etcher includes a chamber having first and second adjoining regions. The etcher further includes a radio frequency source for generating plasma in the first region from delivered gas. A separator is positioned between the first and second regions for transmitting nonionized gas into the second region.

### BACKGROUND OF THE INVENTION

The present invention is generally related to semiconductor device fabrication, and, more particularly, the present invention is related to techniques for reducing sodium contamination that may occur during etch processing of a semiconductor wafer.

It is known that the presence of ionized alkali metal atoms (e.g., Na⁺, K⁺, etc.) in an oxide film of a semiconductor device can result in undesirable mobile ionic charges. For example, when a positive bias is applied to a gate electrode, such ions can drift from the gate electrode to the silicon interface and this can result in MOSFET (Metal Oxide Semiconductor Field Effect Transistor) threshold voltage instability. It will be appreciated that in some applications concentrations of sodium of about more than about 10¹² ions/cm² may result in lowered wafer and semiconductor device yield, and higher overall costs. As suggested above, the sodium contaminant can affect electrically sensitive areas of the devices, and eventually cause failures. Reliability issues have always been a major concern of the space and defense industries. However, even in commercial applications, they cause concern due to lost data, down time for critical equipment, and the high cost of repair or replacement of devices in the field. Contamination control in the manufacturing of semiconductor devices is critical to the performance and profitability of any manufacturing operation of such devices.

Although measures have been instituted to keep the level of sodium contamination well below the limits where instabilities can occur, such measures have not been successful in every case. For example, sodium may be discharged onto the semiconductor wafers during a metal etch processing action due to etching of sodium-containing ceramic components in the main etch equipment used for performing such processing. Generally, such sodium may be removed using conventional “sodium-removal” steps including post-metal-etch oxide etches. Undesirably, however, in one exemplary commonly used etcher, such as the LAM 9600 etcher that uses a DSQ (Decoupled Source Quartz) stripper module to create a plasma to remove or strip a photoresist from the wafers, such sodium may be driven deep into the underlying oxide, making its removal with conventional “sodium-removal” steps virtually impossible. The foregoing exemplary etcher is commercially available from Lam Research Inc.

Various attempts have been made to reduce sodium contamination of semiconductor wafers during the etch process. Some of those attempts involve developing cleaning procedures of the ceramic components used in the main etch equipment to reduce the amount of sodium released during the etch process. Further, use of alternative materials in lieu of ceramic materials has been evaluated without any definitive results to economically and reliably reduce sodium contamination. Unfortunately, as suggested above, the “sodium-removal” steps have proven to be unsuccessful when the sodium is deeply embedded in the oxide layer. Thus, it would be desirable to provide techniques that overcome the above-described difficulties. More particularly, it would be desirable to prevent the sodium from being driven deep into the underlying oxide.

### SUMMARY OF THE INVENTION

Generally, the foregoing needs are fulfilled by providing, in one exemplary embodiment of the invention, a plasma etcher that includes a chamber having first and second adjoining regions. The etcher further includes a radio frequency source for generating plasma in the first region from delivered gas. A separator is positioned between the first and second regions for transmitting nonionized gas into the second region.

The present invention further fulfills the foregoing needs by providing in another aspect thereof, a method of processing a semiconductor wafer in a plasma chamber. The method allows to form a plasma-containing gas in a first portion of the chamber. Respective positioning steps allow to position the wafer in a second portion of the chamber, and to position a separator between the first and second portions of the chamber. Gas in the first region is passed through the separator to assure that gas entering the second region is passed through the separator to assure that gas entering the second region is substantially discharged.

### BRIEF DESCRIPTION OF THE DRAWINGS

FIGS. 1 and 2 illustrate respective exemplary sodium concentration profiles as a function of depth in a semiconductor wafer, and wherein such profiles are provided to assist the reader to better conceptualize the problems solved by the present invention, and, more particularly, FIG. 2 shows a profile subject to relatively deep sodium “drive-in” as compared to the profile of FIG. 1;

FIG. 3 illustrates an exemplary etch chamber susceptible to the sodium “drive-in” effect shown in FIG. 2;

FIG. 4 illustrates a side view schematic of one exemplary embodiment of an etch chamber incorporating a separator in accordance with one aspect of the present invention;

FIG. 5 illustrates a top view illustrating a plurality of passageways in the separator of FIG. 4;

FIG. 6 illustrates a side view schematic of another exemplary embodiment of the etch chamber in accordance with one aspect of the present invention;

FIG. 7 illustrates normalized sodium concentrations as may be achieved with the various embodiments shown in FIGS. 4 and 6; and

FIG. 8 illustrates exemplary slanting arrangements that may be provided for in the passageways in the plasma-containing plate.

Before any embodiment of the invention is explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The inventors of the present invention have experimentally shown that the underlying factors for driving the sodium deep into the oxide is the combined effect of the electric field which generates the plasma and the elevated temperature at which the wafer is processed. In one aspect of the present invention, the “drive-in” effect of the DSQ stripper on the sodium is reduced by modifying the DSQ chamber with plasma-confinement hardware, thus substantially eliminating the electric field.

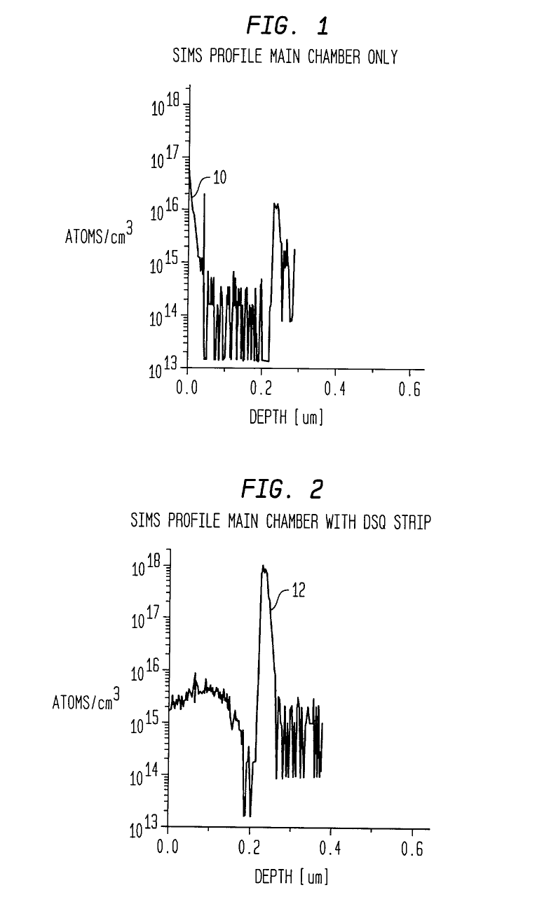

As suggested above, sodium may contaminate the wafer due to etching of the ceramic components in the main etcher. Subsequent processing in the DSQ strip chamber drives the sodium deep into the underlying oxide layer. FIGS. 1 and 2 show respective SIMS ( Secondary Ion Mass Spectrometry) analysis of silicon/silicon oxide wafers respectively illustrating sodium profiles as a function of depth in the oxide. FIG. 1 illustrates the sodium profile for a wafer treated in the main chamber and from such profile it can be appreciated that most of the sodium is concentrated at a depth of less than about 0.1 microns. See for example main lobe 10 adjacent to the vertical axis. FIG. 2 illustrates an exemplary sodium profile representative of the drive-in effect for a wafer treated in the exemplary DSQ strip chamber and from such profile it can be appreciated that most of the sodium is concentrated at a depth of more than about 0.2 microns. See for example main lobe 12 indicative of substantial sodium concentration at a depth of more than about 0.2 microns. As discussed above, the sodium concentration shown in FIG. 2, for all practical purposes, is virtually impossible to remove using standard “sodium-removal” techniques.

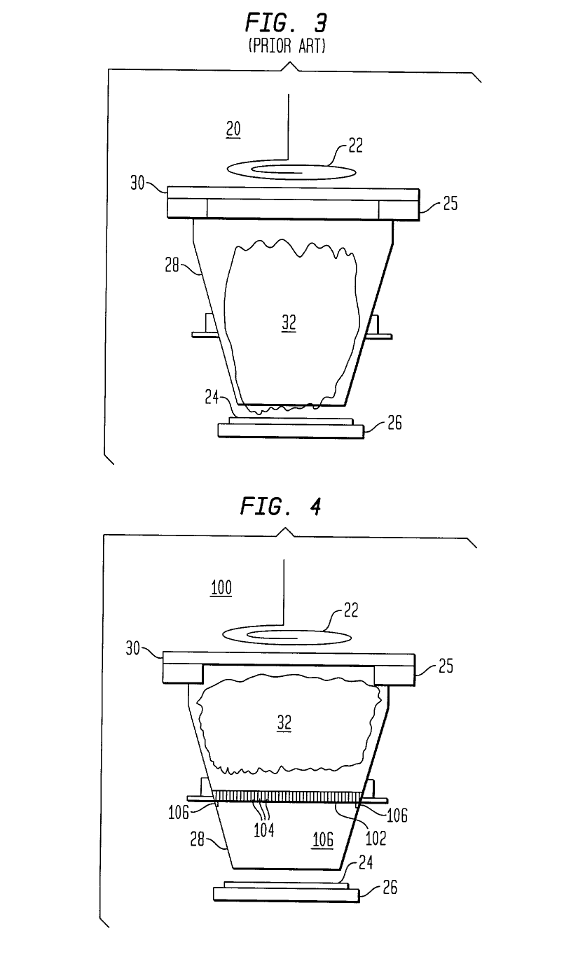

FIG. 3 illustrates a prior art DSQ stripper chamber 20 that applies high-frequency radio frequency (RF) power to one or more reactant gases, e.g., oxygen or other gases, to create the plasma needed to perform the photoresist stripping process. The RF power is applied by way of a coil 22 generally aligned parallel to a wafer 24 situated on a heated wafer-receiving paddle 26. The process gas is delivered through a gas-delivery component 25 to the interior of a quartz funnel 28 enclosed at its upper portion by a quartz window 30. By way of example, the gas-delivery component may comprise a ring, or a shower head gas-delivery component. The plasma generated has a relatively high and uniform ion density through the entire interior of funnel 28, that is, the active plasma region extends through the entire interior of the funnel, as represented by cloud 32. By way of example, molecular oxygen (O₂) is split into its more reactive atomic form (O), which reacts with carbon, hydrogen and other constituents of the organic photoresist material to form gaseous by-products, and thus strip the photoresist from the wafer. The by-products of stripping, e.g., CO, CO₂ and H₂O, are pumped out from the DSQ chamber through suitable exhaust ports (not shown).

As suggested above, it is believed that the sodium drive-in effect is primarily caused by two factors in the DSQ chamber. First, in order to strip the resist, the wafer is processed at an elevated temperature. Second, the plasma in the DSQ chamber extends uncontained throughout the interior of the quartz funnel. That is, the active plasma extends from the region where the gas is introduced into the chamber all the way down to the wafer surface. It is believed that the electric field generated by the plasma coupled with the elevated temperature of the wafer results in the undesirable “drive-in” effect of the sodium.

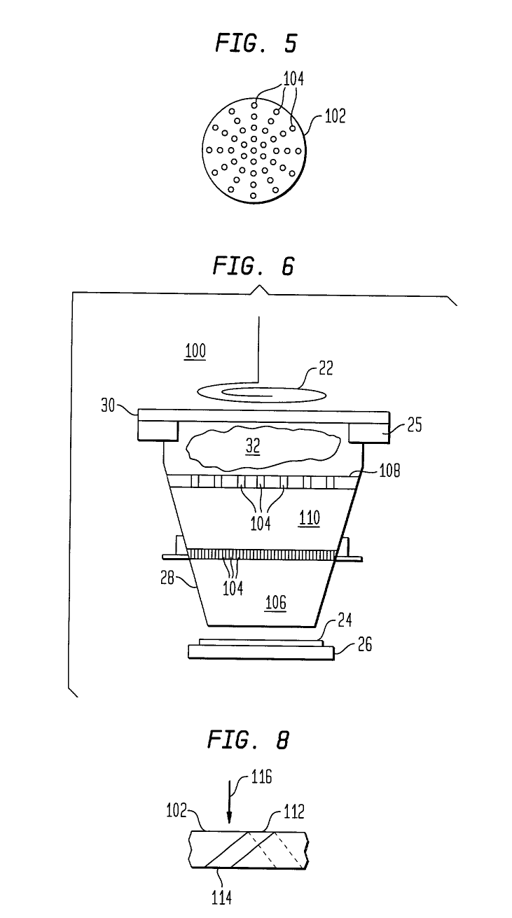

FIG. 4 schematically shows a chamber 100 embodying one aspect of the present invention. As shown in FIG. 4, chamber 100 includes a separator 102 for substantially containing the plasma in a first region of the chamber, e.g., the upper portion of the chamber. In one exemplary embodiment, separator 102 comprises an apertured plate configured to slow down the downward flow of the ionized gases and includes a plurality of passageways 104 configured in one exemplary embodiment like a “showerhead” pattern to allow passage to the ionized gases, as further illustrated in FIG. 5. It will be appreciated that separator 102 need not be configured as an apertured plate since other arrangements, such as a wire mesh screen, could work equally effective in lieu of an apertured plate. Separator 102 causes the ionized gases in the plasma to lose energy and thus return to an electrically neutral state before impinging on the wafer. This allows the uncharged molecules to do the stripping of the photoresist without the high electric field associated with the active plasma region. The inventors of the present invention have recognized that a creation of a substantially plasma-free region 106 enables any sodium previously discharged on the wafer to remain close to the surface of the wafer where such sodium can then be removed using “sodium-removal” steps readily known to those of ordinary skill in the art.

FIG. 6 schematically shows a chamber 200 embodying another aspect of the invention. As shown in FIG. 6, chamber 200 includes, in addition to first separator 102, a second separator 108 that defines an intermediate 110 between regions 32 and 106. In another embodiment, the invention could be implemented using upper separator 108 as a single separator in lieu of the combination of separators 102 and 108, or in lieu of the single separator 102, shown in FIG. 4. By way of example and not of limitation, in one exemplary embodiment, separator 102 may be generally closer to the lower end of funnel 28 than to the upper end of that funnel. Conversely, separator 102 may be generally closer to the upper end of funnel than to the lower end of that funnel.

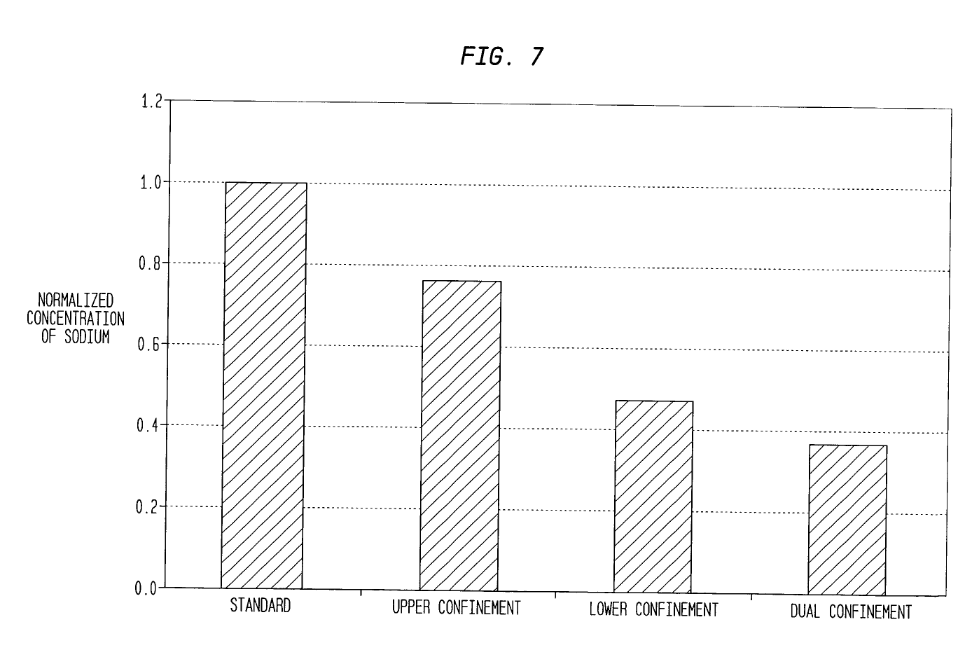

FIG. 7 illustrates exemplary normalized concentrations of sodium in respective oxide layers of a semiconductor device for the various embodiments discussed above. The bar labeled “Standard” shows a normalized unity value in an etcher not incorporating any separator. The bar labeled “Upper Confinement” corresponds to the embodiment that uses only the upper confinement separator, e.g., separator 108 in FIG. 6. The bar labeled “Lower Confinement” corresponds to the embodiment that uses only the lower separator, e.g., separator 102 in FIGS. 4 and 6. The bar labeled “Dual Confinement” corresponds to the embodiment that uses both the lower and upper separators, e.g., separators 102 and 108 in FIG. 6. Although the “Dual Confinement” bar shows the lowest concentration of sodium, it is believed that this embodiment may not necessarily result in the highest stripping of photoresist, and thus, depending on any given application, one may trade off higher or lower sodium concentration against any specific photoresist stripping requirements. It is noted that the results illustrated in FIG. 7 were obtained using a corona discharge measurement technique which, unlike the SIMS measurement technique, does not provide concentration of sodium as a function of depth, but rather provides the total concentration of sodium in the entire oxide film.

In the embodiments discussed above, passageways 104 may comprise respective straight-through passageways, that is, the respective entrance and exit openings are disposed in substantial line of sight relative to one another. FIG. 8 shows an embodiment wherein an entrance opening 112 may not be within the line of sight of an exit opening 114. Since the trajectory of travel of the ionized gases generally follows a downward straight line, as generally conceptualized by a representative line 116, it is believed that the slanting feature shown in FIG. 8 will further aid to bring such ions to an electrically neutral state prior to reaching the semiconductor wafer. In such embodiment, one could configure a pattern of openings in the plasma-containing plate wherein each row of openings would alternate between a slant in one direction and a slant in an opposite direction, as represented by the dashed line in FIG. 8. It will be further appreciated that each row of openings embodying such alternating slanting feature could comprise either circumferentially extending rows along the plasma-containing plate or radially extending rows along the plasma-containing plate.

In another aspect of the invention, each respective separator may be mechanically supported by a suitable mounting ring 106 (FIG. 4). The separator and the mounting ring may further include a key and a key-receiving opening so as to ensure that the plate remains affixed to the mounting ring notwithstanding that the quartz funnel 28 may be moved between respective horizontal and vertical planes for operational purposes. One exemplary material that may be used for the separator and the ring is quartz. However, the invention would work equally effective using other sputtering-resistant materials for the separator and the ring, such as aluminum and other metals or metal alloys.

It should be appreciated that one attractive feature of the present invention is the high degree of simplicity and relatively low cost at which the plasma-containing hardware may be integrated with deployed etchers, such as the LAM 9600 . In fact such hardware may be deployed in kit form to retrofit already deployed etchers without interfering or affecting the etcher installation.

In operation the present invention allows for processing a semiconductor wafer comprising an etched surface and an oxide layer under that surface. The oxide is free of high concentrations of alkali metal atoms beyond a predefined depth below the surface of said wafer. In one exemplary embodiment wherein the concentration of alkali metal atoms comprises sodium atoms, such sodium concentration may be of an order of magnitude of not more than about 10¹² atoms/cm². In that exemplary embodiment, such depth may range from about 100 to 400 Angstroms. It will be appreciated, however, that the present invention is not limited to the foregoing exemplary ranges.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A plasma etcher comprising:
a chamber having first and second adjoining regions;
a gas-delivery component in the first region;
a radio frequency source for generating a plasma in the first region from delivered gas;
a separator positioned between the first and second regions for transmitting nonionized gas into the second region.

2. The etcher of claim 1 wherein the separator comprises an apertured plate.

3. The etcher of claim 1 wherein the separator comprises a mesh screen.

4. The etcher of claim 1 wherein the separator is positioned to inhibit flow of charged particles to the second region.

5. The etcher of claim 1 wherein said separator is generally disposed closer to the lower end of the chamber than to the upper end of said chamber.

6. The etcher of claim 1 wherein said separator is generally disposed closer to the upper end of the chamber than to the lower end of said chamber.

7. The etcher of claim 1 further comprising a second separator disposed to define an intermediate region between said first and second regions.

8. The etcher of claim 2 wherein said apertured plate includes a plurality of passageways comprising respective entrance and exit opening situated to have a straight-through line of sight relative to one another.

9. The etcher of claim 8 wherein said passageways comprises respective entrance and exit openings disposed to avoid a straight-through line of sight relative to one another.

10. The etcher of claim 1 further comprising a mounting ring for receiving the separator.

11. The etcher of claim 10 wherein said mounting ring and the separator are keyed to one another to maintain mechanical coupling to one another regardless of movement between respective generally horizontal and vertical positions.

12. The etcher of claim 1 wherein said second region is sufficiently free of electrically charged molecules to avoid creating a relatively high concentration of alkali metal atoms beyond a predefined depth below a surface of a wafer therein.

13. A method of processing a semiconductor wafer in a plasma chamber, said method comprising:
forming a plasma-containing gas in a first portion of the chamber;
positioning the wafer in a second portion of the chamber;
positioning a separator between the first and second portions of the chamber; and
passing gas in the first region through the separator to assure that gas entering the second region is substantially discharged.

14. The semiconductor processing method of claim 13 further comprising disposing said separator generally closer to the lower end of the chamber than to the upper end of said chamber.

15. The semiconductor processing method of claim 13 further comprising disposing said separator closer to the upper end of the chamber than to the lower end of said chamber.

16. The semiconductor processing method of claim 13 further comprising disposing a second separator to define an intermediate chamber portion between said first and second portions of the chamber.

17. The semiconductor processing method of claim 13 further comprising providing a plurality of passageways in the separator and wherein said passageways comprise respective entrance and exit opening situated to have a straight-through line of sight relative to one another.

18. The semiconductor processing method of claim 17 wherein said passageways comprise respective entrance and exit openings disposed to avoid a straight-through line of sight relative to one another.

19. The semiconductor processing method of claim 13 further comprising receiving the separator in a mounting ring.

20. The semiconductor processing method of claim 13 further comprising keying said mounting ring and the separator to one another to maintain mechanical coupling therebetween regardless of movement between respective generally horizontal and vertical positions.

21. The semiconductor processing method of claim 13 wherein said second portion of the chamber is sufficiently free of electrically charged molecules to avoid creating a relatively high concentration of alkali metal atoms beyond a predefined depth below the surface of said wafer.

22. A semiconductor wafer comprising an etched surface and an oxide layer under said surface, said oxide being free of high concentrations of alkali metal atoms beyond a predefined depth below the surface of said wafer.

23. The semiconductor wafer of claim 22 wherein said predefined depth ranges from about 100 to 400 Angstroms.

24. The semiconductor wafer of claim 23 wherein said concentration of alkali metal atoms comprises a concentration of sodium atoms.

25. The semiconductor wafer of claim 24 wherein said sodium concentration has an order of magnitude of not more than about 10¹² atoms/cm².
